(19) United States
(12) Patent Application Publication
(10) Pub. No.: US 2026/0319416 A1
(43) Pub. Date: Oct. 15, 2026

(54) IMAGE FORMING APPARATUS AND VIBRATION DETECTION METHOD

(71) Applicant: Konica Minolta, Inc., Tokyo (JP)

(72) Inventors: Kuniaki KASHIWAKURA, Aichi (JP); Miyuki KATOU, Tokyo (JP); Toshihiro WAZUMI, Tokyo (JP); Yoshinari MOTOHASHI, Tokyo (JP)

(21) Appl. No.: 19/573,331

(22) Filed: Mar. 20, 2026

(30) Foreign Application Priority Data
Apr. 11, 2025 (JP) 2025-065746

(51) Int. Cl. G03G 15/00; G03G 21/00

(52) U.S. Cl. CPC G03G 15/55; G03G 15/50; G03G 21/0005

(57) ABSTRACT

Provided is an image forming apparatus that includes: an image carrier; a cleaning member that cleans a surface of the image carrier; an image former that forms a predetermined image pattern having regularity on the image carrier; and a hardware processor that specifies a natural frequency of the cleaning member based on a vibration mode of the image carrier when the predetermined image pattern is formed.

### CROSS REFERENCE TO RELATED APPLICATIONS

The entire disclosure of Japanese Patent Application No. 2025-065746, filed on April 11, 2025, is incorporated herein by reference in its entirety.

### BACKGROUND

### Technological Field

The present disclosure relates to an image forming apparatus and a vibration detection method.

### Description of Related Art

In an image forming apparatus (a printer, a copier, a facsimile, or the like) utilizing an electrophotographic process technology, laser light based on image data is emitted to a uniformly charged photoreceptor (a uniformly charged photoconductor is exposed to laser light based on image data) so that an electrostatic latent image is formed on the surface of the photoreceptor. Then, toner is supplied to the photoreceptor so that the electrostatic latent image is visualized as a toner image. The toner image is transferred onto a recording material, and is then heated and pressurized at a fixing section. Through the above steps, an image is formed on the recording material.

In general, an image forming apparatus includes a cleaning apparatus that cleans transfer residual toner on the surface of a photoreceptor (see, for example, Japanese Patent Publication Laid-Open No. 2024-53415 (hereinafter referred to as “PTL 1”)). The cleaning apparatus includes, for example, a cleaning section that removes transfer residual toner, and a lubricant application section that applies a lubricant to the surface of the photoreceptor. The cleaning section includes, for example, a cleaning member that abuts on the surface of the photoreceptor and slides on the surface of the photoreceptor to remove the transfer residual toner. The lubricant application section mainly scrapes off a solid lubricant with a lubricant application member (for example, a lubricant application brush), and applies the lubricant in powder form to the surface of the photoreceptor. Thus, it is possible to achieve a reduction in friction between the photoreceptor and the cleaning member and to suppress wear of the photoreceptor and the cleaning member.

Incidentally, the rotational speed of the photoreceptor is mainly adjusted by controlling the number of rotations of a drive motor. The rotation of the drive motor is transmitted to the photoreceptor via a drive gear. For this reason, the photoreceptor vibrates in a vibration mode including a specific frequency component according to the number of teeth of the drive gear and the rotational speed. The vibration due to the number of teeth of the drive gear and the rotational speed will be referred to as “vibration derived from the driving”.

Although the vibration of the photoreceptor may cause an image defect, an image defect is usually not caused only by the vibration derived from the driving. However, the vibration of the photoreceptor is affected by the vibration transmitted from the cleaning member. The vibration transmitted from the cleaning member will be referred to as “vibration derived from the blade”. The vibration derived from the blade includes natural vibration based on the material, shape, and the like of the cleaning member, and frictional vibration due to the contact with the photoreceptor.

For example, when the frequency derived from the driving and the frequency derived from the blade (the natural frequency of the cleaning member) become close to each other, the photoreceptor comes to vibrate violently due to a resonance phenomenon, which is manifested, for example, as CD pitch unevenness. The CD pitch unevenness is density unevenness or linear noise that periodically appears in a printed image in the rotation direction (sub-scanning direction) of the photoreceptor.

As disclosed in PTL 1, by supplying an appropriate amount of lubricant to the abutting portion between the photoreceptor and the cleaning member, it is possible to reduce the frictional force generated between the photoreceptor and the cleaning member and to suppress the influence of the vibration of the cleaning member. However, PTL 1 makes no mention of a decrease in image quality due to the vibration derived from the blade. In addition, the vibration derived from the blade fluctuates depending on surrounding environmental factors (for example, temperature and humidity) and is also affected by variations in the shape and material of the cleaning member, so that it is difficult to specify the vibration derived from the blade.

### SUMMARY

An object of the present disclosure is to provide an image forming apparatus and a vibration detection method each capable of controlling the vibration mode of a photoreceptor appropriately by detecting a frequency component derived from the blade, reducing image defects such as CD pitch unevenness efficiently, and improving the image quality.

In order to realize at least one of the above-mentioned objects, an image forming apparatus reflecting one aspect of the present disclosure includes:
an image carrier;
a cleaning member that cleans a surface of the image carrier;
an image former that forms a predetermined image pattern having regularity on the image carrier; and
a hardware processor that specifies a natural frequency of the cleaning member based on a vibration mode of the image carrier when the predetermined image pattern is formed.

A vibration detection method reflecting one aspect of the present disclosure includes:
forming a predetermined image having regularity on an image carrier;
detecting a vibration mode of the image carrier when the predetermined image is formed; and specifying, based on a detection result, a natural frequency of a cleaning member that cleans a surface of the image carrier.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating the overall configuration of an image forming apparatus;

FIG. 2 is a diagram illustrating a main part of a control system of the image forming apparatus;

FIGS. 3A and 3B are diagrams that indicate the configuration around a photosensitive drum;

FIG. 4 is a diagram illustrating an example of an analysis result of a vibration mode of the photosensitive drum;

FIG. 5 is a diagram illustrating an example of a ladder pattern that is printed in vibration control processing;

FIG. 6 is a flowchart illustrating an example of the vibration control processing.

FIG. 7 is a diagram illustrating an example of an analysis result of the vibration mode obtained by the vibration control processing through durability; and

FIG. 8 is a diagram illustrating an example of a case where a transfer image of a ladder pattern transferred onto an intermediate transfer belt is read.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present disclosure will be described in detail with reference to the accompanying drawings.

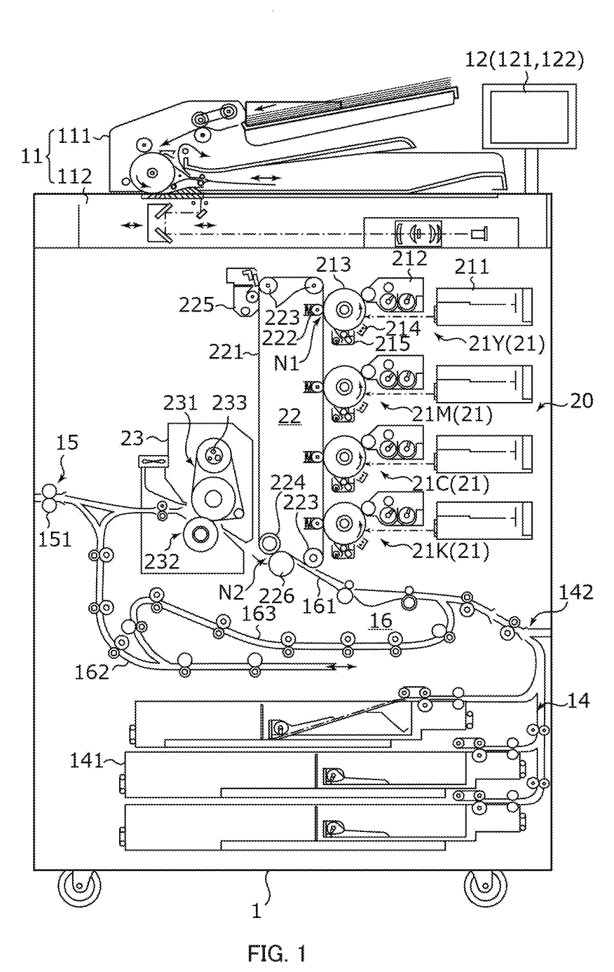

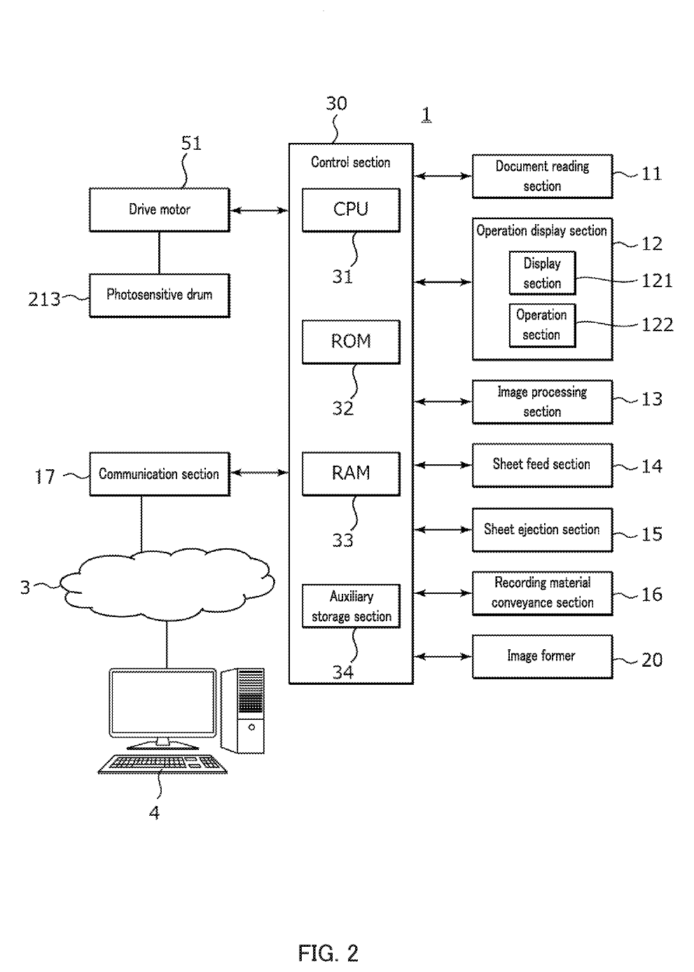

FIG. 1 is a diagram schematically illustrating the overall configuration of an image forming apparatus 1 according to an embodiment. FIG. 2 is a diagram illustrating a main part of a control system of the image forming apparatus 1.

The image forming apparatus 1 is a color image forming apparatus of an intermediate transfer method utilizing an electrophotographic process technology. The image forming apparatus 1 primary transfers toner images of respective colors of yellow (Y), magenta (M), cyan (C), and black (K) formed on photosensitive drums 213 onto an intermediate transfer belt 221. In addition, the image forming apparatus 1 superposes the toner images in the four colors on the intermediate transfer belt 221, and then secondarily transfers the toner images onto a recording material, thereby forming an image. Examples of the recording material include a sheet and a resin film.

In the present embodiment, a vertical tandem system is adopted for the image forming apparatus 1. In the vertical tandem system, the photosensitive drums 213 corresponding to the four colors of CMYK are arranged in series along the vertical direction of the intermediate transfer belt 221, and toner images of the respective colors are sequentially transferred onto the intermediate transfer belt 221 in one sequence.

The image forming apparatus 1 includes a document reading section 11, an operation display section 12, an image processing section 13, a sheet feed section 14, a sheet ejection section 15, a recording material conveyance section 16, a communication section 17, an image former 20, and a control section 30. The image former 20 includes an image creating section 21, an intermediate transfer section 22, and a fixing section 23.

The control section 30 performs overall control of the image forming apparatus 1 by controlling the document reading section 11, the operation display section 12, the image processing section 13, the sheet feed section 14, the sheet ejection section 15, the recording material conveyance section 16, the communication section 17, and the image former 20 according to the respective functions thereof.

The control section 30 includes a central processing unit (CPU) 31 as an arithmetic/control apparatus (processor), a read only memory (ROM) 32 as a main storage apparatus, a random access memory (RAM) 33, and the like. The control section 30 may include an auxiliary storage section 34 constituted by a non-volatile semiconductor memory (so-called flash memory) such as a hard disk drive (HDD), a solid state drive (SSD), or a secure digital (SD) card.

The ROM 32 stores a basic program and basic setting data. In addition, the ROM 32 stores a program, a look-up table, and the like, which are read out when the operation of each block is controlled. The CPU 31 reads a program corresponding to the processing content from the ROM 32, develops the program in the RAM 33, and executes the developed program, thereby controlling the operation of each functional block of the image forming apparatus 1.

In the present embodiment, the function of each functional block is implemented by cooperated operation between each hardware constituting the functional block and the control section 30. Note that, some or all of the functions of the functional blocks may also be implemented by the control section 30 executing a program. In addition, part of processing or the entire processing to be executed by the control section 30 may be executed by an electronic circuit provided according to the processing. Examples of the electronic circuit includes a digital signal processor (DSP), an application specific integrated circuit (ASIC), and a programmable logic device (PLD).

The control section 30 transmits and receives various kinds of data to and from an external apparatus 4 (for example, a computer) connected to a communication network 3 such as a local area network (LAN) or a wide area network (WAN) via the communication section 17. The communication section 17 is, for example, a communication interface such as a network interface card (NIC), a modulator-demodulator (MODEM), or a universal serial bus (USB). The communication section 17 may include a communication interface for short-range wireless communication such as near field communication (NFC) or Bluetooth (registered trademark). The external apparatus 4 is an information processing terminal operated by the user, and examples thereof include a personal computer, a tablet terminal, and a smartphone.

The control section 30 receives, for example, print job data transmitted from the external apparatus 4, and generates input image data based on the received print job data. The print job data is described in a predetermined page description language (PDL). Examples of the print job data includes data of image objects such as graphics and photographs, and data of text objects such as characters and symbols. The generated input image data is temporarily stored in an image memory (illustration is omitted).

When executing a print job, the control section 30 sets image formation conditions based on print setting information of the print job. The print setting information includes sheet setting information and print quality information. The image formation conditions are set by referring to, for example, a look-up table (LUT) stored in advance in the ROM 32.

In addition, the control section 30 performs vibration control processing. The vibration control processing is processing of specifying the natural frequency (the frequency derived from the blade) of a cleaning member 41 and performing control so that no resonance phenomenon occurs at the photosensitive drum 213. The control section 30 functions as a vibration specifying section, a determiner, and an image formation condition setter in the vibration control processing. The vibration control processing will be described in detail later.

The document reading section 11 includes an automatic document feed apparatus 111 called an auto document feeder (ADF), a document image scanning apparatus 112, and the like.

The automatic document feed apparatus 111 conveys a document, which has been placed on a document tray, by a conveyance mechanism and sends the document to the document image scanning apparatus 112. The automatic document feed apparatus 111 makes it possible to continuously read images (including both sides) of a large number of documents placed on the document tray.

The document image scanning apparatus 112 reads a document conveyed from the automatic document feed apparatus 111 onto a contact glass or a document placed on the contact glass. Specifically, the document image scanning apparatus 112 optically scans a document, forms an image of reflected light from the document on a light receiving surface of an imaging element (for example, a charge coupled device (CCD)), and reads a document image. The document reading section 11 generates input image data based on a reading result by the document image scanning apparatus 112. The generated input image data is temporarily stored in an image memory (illustration is omitted).

The operation display section 12 is constituted by, for example, a flat panel display with a touch screen. As the flat panel display, a liquid crystal display, an organic EL display, or the like can be used. The operation display section 12 includes a display section 121 and an operation section 122.

The display section 121 displays various operation screens, image states, operating statuses of functions, and the like according to a display control signal inputted from the control section 30.

The operation section 122 includes various operation keys such as a numeric keypad and a start key. The operation section 122 receives various input operations by the user, and outputs an operation signal to the control section 30. The user can operate the operation section 122 to perform settings related to image formation, such as document setting, image quality setting, magnification setting, application setting, output setting, and recording material setting. In addition, the user can operate the operation section 122 to instruct the execution of the vibration control processing.

The image processing section 13 includes a circuit or the like that performs digital image processing according to initial setting or user setting on the input image data. The image processing section 13 performs, for example, information extraction processing, image conversion processing, image combination processing, image filtering processing, and correction processing. The image former 20 is controlled on the basis of the image data subjected to the pieces of processing described above.

The image creating section 21 forms a toner image by each color toner of a Y component, an M component, a C component, and a K component based on the input image data. The intermediate transfer section 22 transfers the toner image formed by the image creating section 21 onto a recording material. The fixing section 23 fixes the transferred toner image to the recording material.

Specifically, the image creating section 21 is constituted by four image creating sections 21Y, 21M, 21C, and 21K for a Y component, an M component, a C component, and a K component. Since the image creating sections 21Y, 21M, 21C, and 21K have the same configuration, for convenience of illustration and description, common constituent elements are denoted by the same reference signs, and when common constituent elements are distinguished from each other, the common constituent elements are denoted by adding Y, M, C, and K to the reference signs thereof. Note that, in FIG. 1, only the constituent elements of the image creating section 21Y for the Y component are denoted by the reference signs, and the reference signs for the constituent elements of the other image creating sections 21M, 21C, 21K are omitted.

The image creating section 21 includes an exposure apparatus 211, a developing apparatus 212, the photosensitive drum 213, a charging apparatus 214, a drum cleaning apparatus 215, and the like. Although illustration is omitted, the image creating section 21 may include a static elimination apparatus for removing residual charge remaining on the surface of the photosensitive drum 213 after the primary transfer.

The photosensitive drum 213 is, for example, a negative charge type organic photoconductor (OPC). A drive motor 51 is connected to the photosensitive drum 213 via a gear transmission mechanism including drive gears 52 and 53. The number of rotations of the drive motor 51 is controlled by the control section 30.

The photosensitive drum 213 has a configuration in which, for example, an undercoat layer, a charge generation layer, and a charge transport layer are sequentially laminated on a periphery surface of a conductive cylindrical body made of aluminum (aluminum tube). The charge generation layer is composed of an organic semiconductor in which a charge generation material (for example, phthalocyanine pigment) is dispersed in a resin binder (for example, polycarbonate). The charge generation layer generates a pair of positive charge and negative charge upon exposure by the exposure apparatus 211. The charge transport layer has a configuration in which a hole transport material (electron-donating nitrogen-containing compound) is dispersed in a resin binder (for example, polycarbonate resin). The charge transport layer transports positive charge generated in the charge generation layer to the surface of the charge transport layer.

The charging apparatus 214 is constituted by, for example, a corona discharge generator such as a scorotron charging apparatus or a corotron charging apparatus. The control section 30 controls a charging bias application section (illustration is omitted) so that a charging bias is applied to the charging apparatus 214. The charging bias application section is, for example, a DC power supply circuit. The charging apparatus 214 generates corona discharge by the application of a charging bias and uniformly charges the surface of the photosensitive drum 213 to a negative polarity. The surface potential of the photosensitive drum 213 depends on the charging bias.

The exposure apparatus 211 includes, for example, an LED print head (LPH). The LPH includes an LED array, an LPH driving section (driver IC), a lens array, and the like. In the LED array, a plurality of light emitting diodes (LEDs) is linearly arranged. The LPH driving section drives each LED. The lens array forms an image of light emitted from the LED array on the photosensitive drum 213. One LED of the LED array corresponds to one dot of an image.

The exposure apparatus 211 emits light corresponding to an image of each color component to the photosensitive drum 213. The positive charge generated in the charge generation layer of the photosensitive drum 213 by receiving light emission is transported to the surface of the charge transport layer, and thus, the surface charge (negative charge) of the photosensitive drum 213 is neutralized. Thus, an electrostatic latent image of each color component is formed on the surface of the photosensitive drum 213 due to a potential difference from the surroundings.

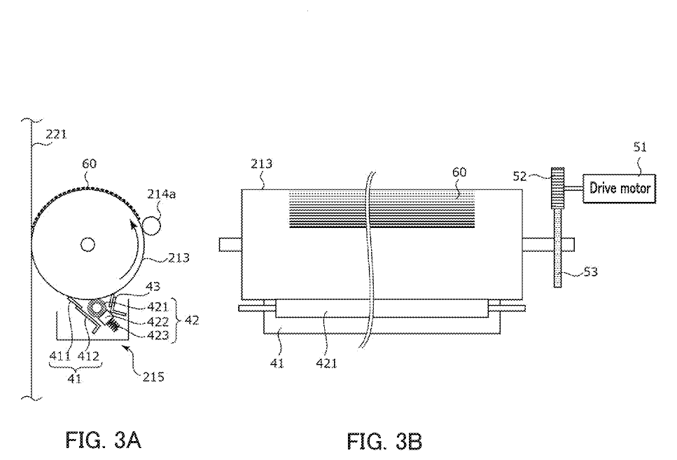

The developing apparatus 212 accommodates a developer (for example, a two-component developer including toner and carrier) of each color component and attaches toner of each color component to the surface of the photosensitive drum 213 to visualize the electrostatic latent image and form a toner image. The control section 30 controls a developing bias application section (illustration is omitted) so that a developing bias is applied to a developer carrier 212a (see FIG. 3). The developing bias application section is, for example, a DC power supply circuit. The developing bias application section may also include an AC power supply circuit in addition to the DC power supply circuit. The developer carrier 212a is, for example, a developing roller.

A developing bias is applied to the developer carrier 212a, and an electric field is formed between the photosensitive drum 213 and the developer carrier 212a. Due to a potential difference between the photosensitive drum 213 and the developer carrier 212a, the charging toner on the developer carrier 212a flies to and adheres to an image portion (exposed portion) of the surface of the photosensitive drum 213. Thus, the electrostatic latent image on the photosensitive drum 213 is visualized.

The drum cleaning apparatus 215 removes transfer residual toner remaining on the surface of the photosensitive drum 213 after the primary transfer. A detailed configuration of the drum cleaning apparatus 215 will be described later.

The intermediate transfer section 22 includes the intermediate transfer belt 221, a primary transfer roller 222, a plurality of support rollers 223 and 224, a belt cleaning apparatus 225, a secondary transfer roller 226, and the like.

The intermediate transfer belt 221 is an image carrier that carries a toner image, and is a transfer-receiving body onto which the toner image on the photosensitive drum 213 is transferred. The intermediate transfer belt 221 is constituted by a belt having an endless shape and is stretched in a loop shape around the plurality of support rollers 223. At least one of the plurality of support rollers 223 is constituted by a drive roller, and the other support rollers 223 are constituted by driven rollers. As the drive roller rotates, the intermediate transfer belt 221 travels at a constant speed.

The primary transfer roller 222 is disposed on the inner periphery surface side of the intermediate transfer belt 221 so as to face the photosensitive drum 213 of each color component. When the primary transfer roller 222 is brought into pressure contact with the photosensitive drum 213 with the intermediate transfer belt 221 interposed therebetween, a primary transfer nip for transferring a toner image from the photosensitive drum 213 onto the intermediate transfer belt 221 is formed. The control section 30 controls a transfer bias application section (illustration is omitted) so that a primary transfer bias is applied to the primary transfer roller 222.

The support rollers 223 includes an opposing roller 224 disposed to face the secondary transfer roller 226. The secondary transfer roller 226 is disposed on the outer periphery surface side of the intermediate transfer belt 221 and is brought into pressure contact with the opposing roller 224 with the intermediate transfer belt 221 interposed therebetween. Thus, a secondary transfer nip for transferring a toner image from the intermediate transfer belt 221 onto the recording material is formed. The control section 30 controls a transfer bias application section (illustration is omitted) so that a secondary transfer bias is applied to the secondary transfer roller 226.

At the primary transfer nip N1, the toner images on the photosensitive drums 213 are sequentially primary transferred in a superposed manner onto the intermediate transfer belt 221. Specifically, when a primary transfer bias is applied to the primary transfer roller 222, a charge having a polarity opposite to that of the toner is applied to an inner periphery surface side of the intermediate transfer belt 221 (the side on which the intermediate transfer belt 221 abuts on the primary transfer roller 222). The toner image is electrostatically transferred from the photosensitive drum 213 onto the intermediate transfer belt 221.

Thereafter, when the recording material passes through the secondary transfer nip N2, the toner image on the intermediate transfer belt 221 is secondarily transferred onto the recording material. Specifically, when a secondary transfer bias is applied to the secondary transfer roller 226, a charge having a polarity opposite to that of the toner is applied to the rear surface side of the recording material (the side on which the recording material abuts on the secondary transfer roller 226). The toner image is electrostatically transferred from the intermediate transfer belt 221 onto the recording material. The recording material onto which the toner image has been transferred is conveyed toward the fixing section 23.

The belt cleaning apparatus 225 includes a belt cleaning blade (reference sign is omitted) that comes into sliding contact with the surface of the intermediate transfer belt 221, and the like. The belt cleaning apparatus 225 removes transfer residual toner remaining on the surface of the intermediate transfer belt 221 after the secondary transfer.

The fixing section 23 includes an upper fixing section 231, a lower fixing section 232, a heating source 233, a pressure contact/separation section (illustration is omitted), and the like. The upper fixing section 231 includes a fixing surface side member disposed on the side of a fixing surface (the surface on which a toner image is formed) of the recording material. The lower fixing section 232 includes a rear surface side support member disposed on the side of a rear surface (the surface opposite to the fixing surface) of the recording material. The heating source 233 heats the fixing surface side member. The pressure contact/separation section brings the rear surface support member into pressure contact with the fixing surface side member.

The recording material onto which the toner image has been secondarily transferred and which has been conveyed along a sheet passage path is heated and pressurized when passing through the fixing section 23. Thus, the toner image is fixed to the recording material.

The sheet feed section 14 includes a sheet feed tray 141 and a manual sheet feed section 142. In the sheet feed tray 141, sheets (standard sheets and special sheets) identified based on the basis weight, size, and the like are accommodated for each sheet type set in advance. A plurality of sheet feed roller sections (reference sign is omitted) is disposed in the sheet feed tray 141 and the manual sheet feed section 142. An external sheet feed apparatus having a large capacity (illustration is omitted) can be connected to the manual sheet feed section 142. The external sheet feed apparatus may be capable of feeding a continuous sheet such as a roll sheet, for example. The sheet feed section 14 sends out a recording material, which has been fed from the sheet feed tray 141 or the manual sheet feed section 142, to the recording material conveyance section 16.

The sheet ejection section 15 includes a sheet ejection conveyance roller section 151. The sheet ejection section 15 ejects the recording material, which has been sent out from the recording material conveyance section 16, to the outside of the apparatus.

The recording material conveyance section 16 includes a main conveyance section 161, a switchback conveyance section 162, a rear surface printing conveyance section 163, a sheet passage path switching section (illustration is omitted), and the like. Part of the recording material conveyance section 16 may be incorporated, together with the fixing section 23, into one unit, for example, and may be detachably attached to the image forming apparatus 1.

The main conveyance section 161 includes a recording material conveyance element that sandwiches and conveys a recording material. Examples of the recording material conveyance element include a plurality of conveyance roller sections (reference sign is omitted) including a loop roller section and a registration roller section. The main conveyance section 161 conveys a recording material fed from the sheet feed section 14 and passes the recording material to the image former 20 (the intermediate transfer section 22 and the fixing section 23). In addition, the main conveyance section 161 conveys a recording material, which has been sent out from the image former 20 (the fixing section 23), toward the sheet ejection section 15 or the switchback conveyance section 162.

The switchback conveyance section 162 temporarily stops the recording material sent out from the fixing section 23, reverses the conveyance direction, and conveys the recording material to the sheet ejection section 15 or the rear surface printing conveyance section 163.

The rear surface printing conveyance section 163 circulates and conveys the recording material, which has been switched back by the switchback conveyance section 162, to the main conveyance section 161. The recording material is passed through the main conveyance section 161 in a state in which the rear surface is an image forming surface.

The sheet passage path switching section (illustration is omitted) is disposed on the downstream side of the fixing section 23 in the recording material conveyance direction. The sheet passage path switching section switches the sheet passage path depending on whether the recording material, which has been sent out from the fixing section 23, is ejected as it is, is flipped and dejected, or is conveyed to the rear surface printing conveyance section 163. Specifically, the control section 30 controls the operation of the sheet passage path switching section (illustration is omitted) on the basis of the processing content (single-sided/double-sided printing, face-up/face-down ejection, and the like) of the image formation processing.

The recording material fed from the sheet feed section 14 is conveyed to the image former 20 by the main conveyance section 161. Then, when the recording material passes through the secondary transfer section, the toner images on the intermediate transfer belt 221 are collectively transferred onto a first surface (front surface) of the recording material, and fixing processing is performed at the fixing section 23. The recording material on which an image has been formed is ejected to the outside of the apparatus by the sheet ejection section 15. In a case where images are formed on both surfaces of a recording material, the recording material, on the first surface of which an image has been formed, is sent out to the switchback conveyance section 162. Then, the recording material is flipped by returning to the main conveyance section 161 through the rear surface printing conveyance section 163, and an image is formed on a second surface (the rear surface).

FIGS. 3A and 3B are diagrams that indicate the configuration around a photosensitive drum. As illustrated in FIGS. 3A and 3B, the drum cleaning apparatus 215 includes a cleaning member 41, a lubricant application member 42, and a leveling member 43. The cleaning member 41, the lubricant application member 42, and the leveling member 43 are attached to a storage case (reference sign omitted), which serves as a frame body of the drum cleaning apparatus 215, by an appropriate method. The drum cleaning apparatus 215 is integrally attached as a photoreceptor unit, for example, together with the photosensitive drum 213, to the image forming apparatus 1.

The present embodiment adopts a downstream application system in which the lubricant application member 42 is disposed downstream of the cleaning member 41 in the rotation direction of the photosensitive drum 213. Note that, the lubricant application method may also be an upstream application method in which the lubricant application member 42 is disposed upstream of the cleaning member 41 in the rotation direction of the photosensitive drum 213.

The cleaning member 41 includes a cleaning blade 411 and a blade supporting sheet metal 412. The cleaning blade 411 abuts on the surface of the photosensitive drum 213. The blade supporting sheet metal 412 supports the cleaning blade 411 so that the cleaning blade 411 in a predetermined posture abuts on the photosensitive drum 213.

The cleaning blade 411 is an elastic member obtained by molding, for example, urethane rubber or the like into a flat plate shape. The cleaning blade 411 has a width substantially equal to the width of the photosensitive drum 213 in the longitudinal direction (the main scanning direction). For example, the cleaning blade 411 is disposed so as to be in sliding contact with the photosensitive drum 213 at a predetermined contact angle (for example, 15°) from a counter direction (a direction in which an edge portion is stretched when the photosensitive drum 213 rotates).

The lubricant application member 42 includes a lubricant application brush 421, a solid lubricant 422, and a lubricant pressing section 423. The lubricant application brush 421 is, for example, a roller-like brush formed by winding a base fabric, in which fibers such as polyester are implanted, around a core metal. The lubricant application brush 421 has a width substantially equal to the width of the photosensitive drum 213 in the axial direction. The lubricant application brush 421 is fixed such that the surface of the photosensitive drum 213 bites into the tip of the brush by a predetermined amount (for example, a biting amount of 0.5 mm to 1.5 mm). A drive motor (illustration is omitted) is connected to the lubricant application brush 421 via a gear transmission mechanism.

The solid lubricant 422 is obtained by solidifying a lubricant into a rod shape, and has a predetermined hardness (for example, pencil hardness equivalent to F to HB). As the lubricant, for example, zinc stearate (ZnSt) is applied.

The lubricant pressing section 423 includes, for example, a biasing member such as a compression spring. The lubricant pressing section 423 presses the solid lubricant 422, which is fixed to one end side of the biasing member, toward the lubricant application brush 421 at a predetermined pressure. The pressing force applied by the lubricant pressing section 423 may be variably controllable.

The leveling member 43 is a flat plate-like member having a width substantially equal to the width of the photosensitive drum 213 in the longitudinal direction. A portion of the leveling member 43, which is in sliding contact with the photosensitive drum 213, is formed of an elastic body such as urethane rubber. The leveling member 43 is disposed on the downstream side of the lubricant application member 42 in the rotation direction of the photosensitive drum 213. The leveling member 43 is disposed so as to be in sliding contact with the photosensitive drum 213 at a predetermined contact angle (for example, 50°) from a trailing direction (a direction in which an edge portion is dragged when the photosensitive drum 213 rotates).

At the time of image formation, the cleaning blade 411 scrapes off transfer residual toner remaining on the surface of the photosensitive drum 213 as the photosensitive drum 213 rotates. The scraped transfer residual toner is sent out to a waste toner collection container (illustration is omitted).

In addition, as the control section 30 controls the drive motor, the lubricant application brush 421 rotates in a direction (counter direction) opposite to the rotation of photosensitive drum 213. As the lubricant application brush 421 rotates, the lubricant is scraped off from the surface of the solid lubricant 422 and the scraped lubricant is applied to the photosensitive drum 213. The applied lubricant is leveled by the leveling member 43 so as to have a uniform thickness.

The amount of the solid lubricant 422 scraped off by the lubricant application brush 421 (hereinafter, this amount will be referred to as “lubricant application amount”) can be controlled by lubricant application conditions. The “lubricant application conditions” are an example of the image formation conditions. The lubricant application conditions include, for example, the number of rotations of the lubricant application brush 421 (the number of rotations of the drive motor) and the pressing force applied by the lubricant pressing section 423. In the present embodiment, the lubricant application amount is controlled by controlling the number of rotations of the lubricant application brush 421. The number of rotations of the lubricant application brush 421 is represented by, for example, a peripheral speed ratio (called lubricant θ) with respect to the photosensitive drum 213.

In the above-described configuration, the rotational speed of the photosensitive drum 213 is adjusted by controlling the number of rotations of the drive motor 51. The rotation of the drive motor 51 is transmitted to the photosensitive drum 213 via the drive gears 52 and 53. For this reason, the vibration mode of the photosensitive drum 213 includes a frequency component derived from the driving according to the number of teeth of the drive gears 52 and 53 and the rotational speed.

In addition, a stress is generated at the cleaning blade 411 due to friction with the photosensitive drum 213. The blade supporting sheet metal 412 supporting the cleaning blade 411 vibrates at the natural frequency of the sheet metal itself in response to the stress fluctuation of the cleaning blade 411. Since the vibration of the blade supporting sheet metal 412 is transmitted to the photosensitive drum 213, the vibration mode of the photosensitive drum 213 includes a frequency component derived from the blade, which corresponds to the natural frequency of the cleaning member 41.

The frequency derived from the driving can be experimentally acquired in advance. On the other hand, the frequency derived from the blade cannot be experimentally acquired in advance. This is because the frequency derived from the blade fluctuates depending on the durability of the photosensitive drum 213 and the cleaning member 41 and surrounding environmental factors (for example, temperature and humidity), and is also affected by variations in the shape and material of the cleaning member 41.

In the present embodiment, by forming a predetermined image pattern having regularity, specifically a ladder pattern 60, on the photosensitive drum 213, the frequency component derived from the blade is intentionally amplified and detected in the vibration mode of the photosensitive drum 213. Then, by performing control so that the difference between the frequency derived from the blade and the frequency derived from the driving does not become too small, the occurrence of a resonance phenomenon at the photosensitive drum 213 is prevented.

The vibration mode of the photosensitive drum 213 can be acquired, for example, by analyzing fluctuations in the drive torque of the photosensitive drum 213. The control section 30 performs feedback control in which a current value is adjusted in a real time so that the number of rotations of the driving motor 51 is stabilized. For this reason, the drive torque of the photosensitive drum 213 is reflected in the drive current. Accordingly, the vibration mode of the photosensitive drum 213 can be acquired by analyzing fluctuations in the drive current of the drive motor 51.

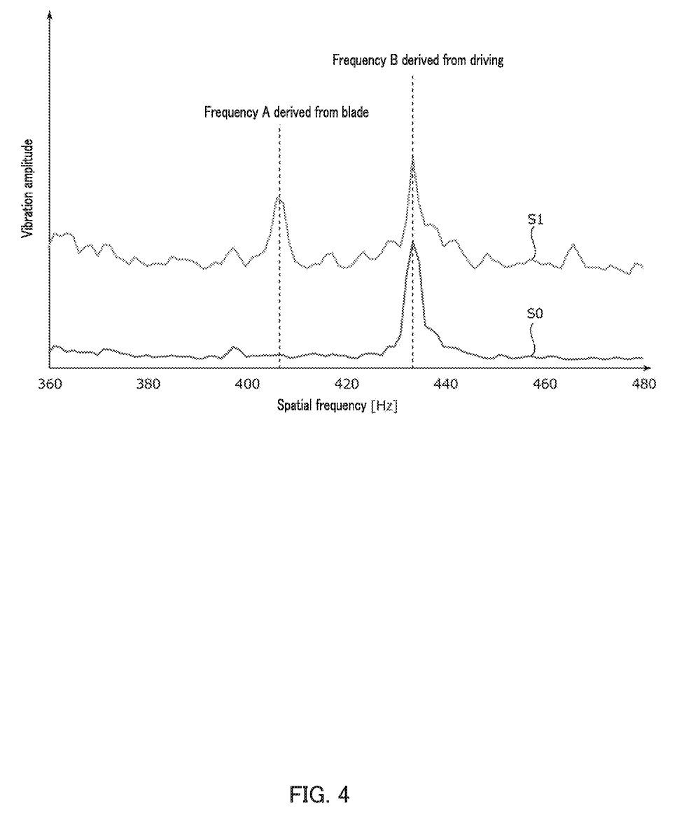

FIG. 4 is a diagram illustrating an example of an analysis result of the vibration mode of the photosensitive drum 213. Specifically, FIG. 4 illustrates an amplitude spectrum obtained by forming a predetermined image pattern on the photosensitive drum 213, measuring fluctuations in the drive current of the drive motor 51 during that period, and performing Fourier transform thereon. Main frequency components in the vibration mode of the photosensitive drum 213 can be read from FIG. 4.

An amplitude spectrum S0 in FIG. 4 is an analysis result when a uniform halftone image pattern is output. A peak appears around 434 Hz. It can be said that this peak is of a frequency component derived from the driving.

An amplitude spectrum S1 in FIG. 4 is an analysis result when a ladder pattern of 1.6 mm pitch is output. The ladder pattern is an example of an image pattern having regularity, and is a stripe pattern formed at a uniform pitch in the rotation direction of the photosensitive drum 213 in which white (solid color) and black are alternately arranged. In the amplitude spectrum S1, a peak of the frequency component derived from the driving appears around 434 Hz in the same manner as in the amplitude spectrum S0.

In a case where a ladder pattern with a predetermined pitch is output, the vibration derived from the ladder pattern is combined with the vibration mode of the photosensitive drum 213. At this time, when the vibration derived from the ladder pattern and the vibration derived from the blade substantially coincide with each other in frequency and phase, the both interfere with each other and strengthen each other, so that the frequency component is amplified.

In the amplitude spectrum S1, a peak appears around 407 Hz. The rotational speed of the photosensitive drum 213 is 665 mm/s, and 665 [mm/s] divided by 1.63 [mm] equals 407 [Hz]. Accordingly, it can be said that this peak is of the frequency component derived from the blade. That is, the amplitude spectrum S1 indicates that the frequency derived from the blade substantially coincides with the spatial frequency corresponding to 1.6 mm pitch, and thus, this frequency component is amplified in the vibration mode of the photosensitive drum 213. In a case where the pitch of the ladder pattern is P, the spatial frequency is represented by 1/P.

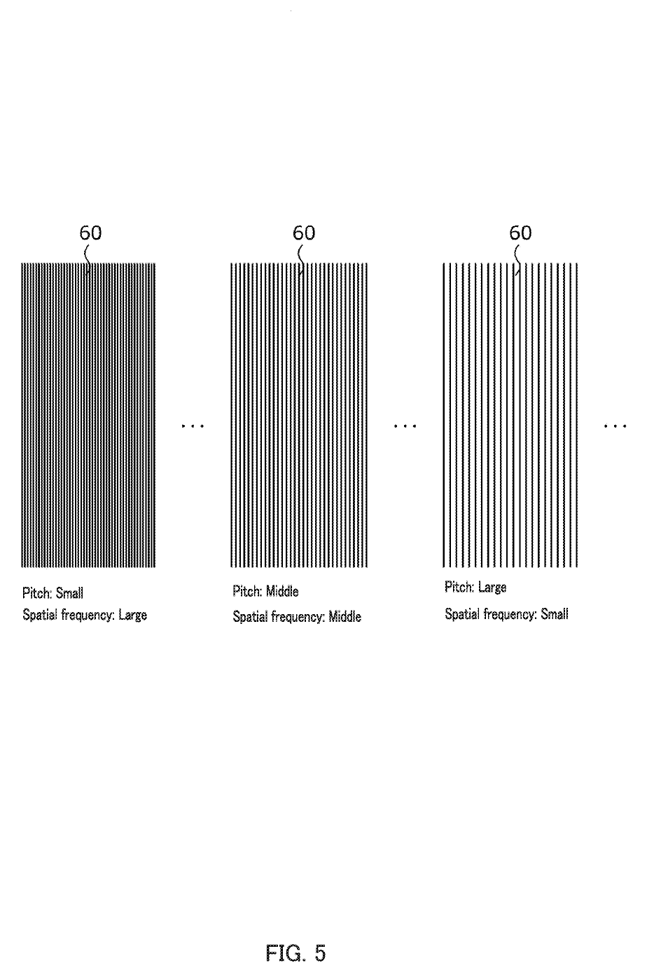

In a case where a plurality of ladder patterns 60 having different pitches is continuously formed as illustrated in FIG. 5, a plurality of frequency components derived from the ladder patterns is combined with the vibration mode of the photosensitive drum 213. When the frequency component derived from the blade and the frequency component derived from any one of the ladder patterns coincide with each other, this frequency component is amplified and a peak appears. Accordingly, by continuously forming a plurality of ladder patterns 60 having different pitches and performing frequency analysis on fluctuations in the drive current of the drive motor 51, that is, the vibration mode of the photosensitive drum 213, it is possible to specify the frequency component derived from the blade.

Note that, although three ladder patterns 60 having different pitches are illustrated in FIG. 5, the pitches of ladder patterns 60 and the number of ladder patterns 60 are merely an example and the present disclosure is not limited thereto. The pitches of ladder patterns 60 and the number of ladder patterns 60 are set so that the frequency derived from the blade which may cause resonance at the photosensitive drum 213 can be detected. The pitches of ladder patterns 60 and the number of ladder patterns 60 can be appropriately set in consideration of, for example, the detection accuracy of the frequency derived from the blade, the rotational speed of the photosensitive drum 213, the toner consumption amount and the detection time required for the detection, and the like.

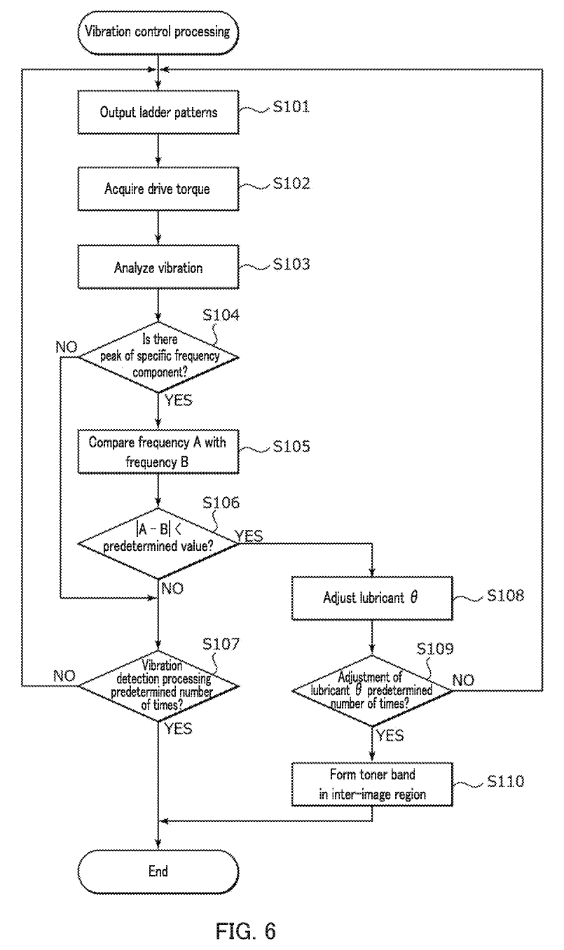

FIG. 6 is a flowchart illustrating an example of the vibration control processing. This processing is realized, for example, by the CPU 31 executing a vibration control processing program accommodated in the ROM 32 at a predetermined timing such as the start time or the end time of a print job. Note that, the vibration detection processing may be executed in response to a user operation performed on the operation section 122.

In step S101 of FIG. 6, the control section 30 causes a plurality of ladder patterns 60 having different pitches to be formed on the photosensitive drum 213. By forming the ladder patterns 60 on the photosensitive drum 213, frequency components corresponding to the pitches (spatial frequencies) of the ladder patterns 60, that is, frequency components derived from the ladder patterns, are combined with the vibration mode of the photosensitive drum 213.

In step S102, the control section 30 acquires the drive torque of the drive motor 51 while the ladder patterns 60 are output. Specifically, the control section 30 acquires, as the drive torque, the drive current of the drive motor 51 during the feedback control. Note that, the drive torque may be acquired by directly measuring the torque applied to the rotation shaft of the drive motor 51 with a sensor.

In step S103, the control section 30 analyzes the frequency components of the drive torque acquired in step S102 (processing as the vibration specifying section). Specifically, the control section 30 performs Fourier transform on the drive torque that fluctuates with time, and decomposes the drive torque into components for each frequency to generate an amplitude spectrum (see FIG. 4). This amplitude spectrum indicates the vibration mode of the photosensitive drum 213, and includes a frequency component derived from the driving, a frequency component derived from the blade, and frequency components derived from the ladder patterns.

In step S104, the control section 30 determines whether there is a peak of a specific frequency component different from the frequency component derived from the driving in the vibration mode of the photosensitive drum 213 (processing as the vibration specifying section). In a case where there is a peak of a specific frequency component (“YES” in step S104), the control section 30 proceeds to the processing in step S105. In a case where there is no peak of a specific frequency component (“NO” in step S104), the control section 30 proceeds to the processing in step S107.

For example, when the frequency of the vibration derived from the blade is substantially the same as the frequency of any one of the vibrations derived from the plurality of ladder patterns having different pitches, a peak of this frequency component appears. In this case, the vibration derived from the blade may cause resonance at the photosensitive drum 213. On the other hand, in a case where a peak of a specific frequency component different from the frequency component derived from the driving is not detected, the frequencies derived from the ladder patterns and the frequency derived from the blade are largely different from each other, so that the possibility that the vibration derived from the blade will cause resonance at the photosensitive drum 213 is low.

In step S105, the control section 30 specifies a frequency A derived from the blade (processing as the vibration specifying section). In a case where a peak of a specific frequency component different from the frequency component derived from the driving is detected in the vibration mode of the photosensitive drum 213, the peak is a peak of the frequency component derived from the blade, so that the frequency of the peak can be specified as the frequency A derived from the blade.

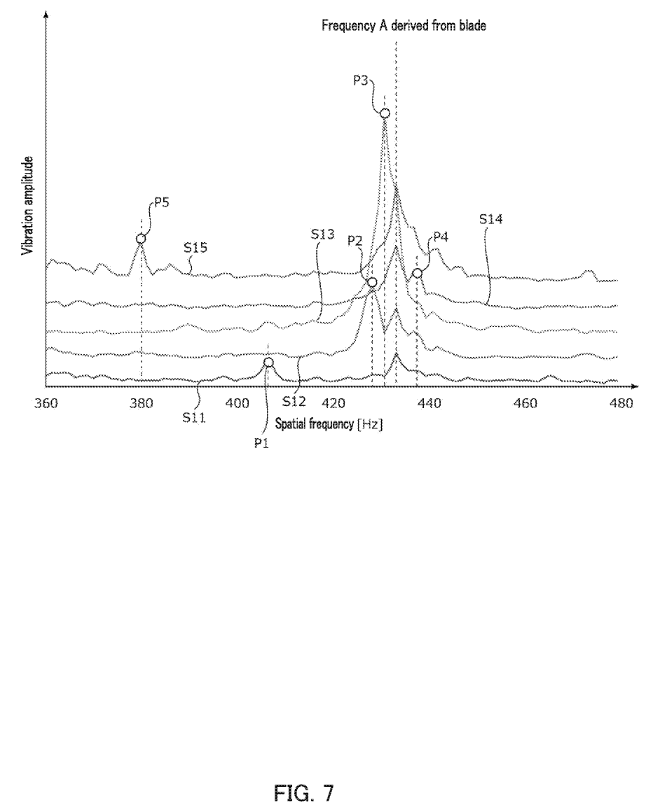

In step S106, the control section 30 determines whether the absolute value of the difference between the frequency A derived from the blade and a frequency B derived from the driving is less than a predetermined value C. The frequency B derived from the driving of the photosensitive drum 213 has been experimentally acquired in advance and stored in, for example, the ROM 32. The predetermined value C is a frequency range in which the vibration derived from the driving and the vibration derived from the blade may resonate. The predetermined value C can be obtained, for example, experimentally. For example, in a case where amplitude spectra S12 and S13 illustrated in FIG. 7 are obtained, the predetermined value C is set to 5 Hz.

In a case where the absolute value of the difference between the frequencies A and B is less than the predetermined value C (“YES” in step S106), that is, in a case where there is a possibility that resonance will occur at the photosensitive drum 213 due to vibration derived from the driving, the control section 30 proceeds to the processing in step S108. In a case where the absolute value of the difference between the frequencies A and B is not less than the predetermined value C (“NO” in step S106), that is, in a case where there is a low possibility that resonance will occur at the photosensitive drum 213 due to the vibration derived from the driving, the control section 30 proceeds to the processing in step S107.

In step S107, the control section 30 determines whether the vibration detection processing in steps S101 to S106 has been performed a predetermined number of times. In a case where the vibration detection processing has been performed the predetermined number of times (“YES” in step S107), it can be determined that the photosensitive drum 213 is less likely to resonate due to the vibration derived from the blade, and the control section 30 ends the vibration control processing. In a case where the vibration detection processing has not been performed the predetermined number of times (“NO” in step S107), the control section 30 proceeds to the processing in step S101.

The predetermined number of times may be twice or more times, and is set to three times, for example. In the vibration mode of the photosensitive drum 213 obtained by the vibration detection processing in steps S101 to S106, in a case where the frequency derived from the blade and the frequencies derived from the ladder patterns substantially coincide with each other and the phases of the both coincide with each other, the frequencies strengthen each other due to interference and a peak appears. On the other hand, in a case where the phases of the both are opposite to each other, the frequencies cancel each other out due to interference. By performing the vibration detection processing a plurality of times, the probability that the phases of the both will coincide with each other increases, and thus, it is possible to ensure that the vibration derived from the blade having a resonance risk is detected.

In step S108, the control section 30 adjusts the rotational speed (lubricant θ) of the lubricant application brush 421. The control section 30 causes the rotational speed of the lubricant application brush 421 to increase, for example. As the amount of lubricant applied to the photosensitive drum 213 increases, the frictional force between the photosensitive drum 213 and the cleaning member 41 decreases, and the frictional vibration generated at the cleaning member 41 decreases. As a result, the frequency derived from the blade changes, the frequency component derived from the blade can be kept away from the frequency component derived from the driving, and it is possible to prevent resonance from occurring at the photosensitive drum 213. Note that, instead of the adjustment of the rotational speed of the lubricant application brush 421, or in addition to the adjustment of the rotational speed of the lubricant application brush 421, the pressing force by the lubricant pressing section 423 may be adjusted.

In step S109, the control section 30 determines whether the adjustment of the rotational speed of the lubricant application brush 421 has been performed a predetermined number of times. In a case where the adjustment of the rotational speed of the lubricant application brush 421 has been performed the predetermined number of times (“YES” in step S109), the control section 30 proceeds to the processing in step S110. In a case where the adjustment of the rotational speed of the lubricant application brush 421 has not been performed the predetermined number of times (“NO” in step S109), the control section 30 proceeds to the processing in step S101. The predetermined number of times may be once or more times, and is set to, for example, three times.

In step S109, in a case where the number of times of adjustment of the rotational speed of the lubricant application brush 421 has reached the predetermined number of times, the frequency component derived from the blade cannot be sufficiently kept away from the frequency component derived from the driving by the adjustment of the rotational speed of the lubricant application brush 421.

In this case, in step S110, the control section 30 causes a toner band having a predetermined width to be formed in an inter-image region of the photosensitive drum 213. The inter-image region is a non-image region between images in the rotation direction of the photosensitive drum 213. This toner band is not transferred onto the intermediate transfer belt 221 and is supplied as residual toner to the cleaning blade 411. The frictional force between the photosensitive drum 213 and the cleaning member 41 is reduced, and the frictional vibration generated in the cleaning member 41 becomes much smaller. As a result, the frequency derived from the blade changes, the frequency component derived from the blade can be kept away from the frequency component derived from the driving, and it is possible to prevent resonance from occurring at the photosensitive drum 213.

Since a toner band is formed only in a case where the frictional vibration at the cleaning member 41 cannot be sufficiently suppressed by the adjustment of the rotational speed of the lubricant application brush 421, it is possible to reduce the toner consumption amount for suppressing the frictional vibration. Note that, in a case where a toner band is formed at a predetermined timing so that the residual toner is forcibly supplied to the cleaning member 41, the amount of toner for forming a toner band may be increased.

In step S109, when the frequency component derived from the blade is kept away from the frequency component derived from the driving before the number of times of adjustment of the rotational speed of the lubricant application brush 421 reaches the predetermined number of times, the vibration control processing ends after the processing in steps S106 and S107. By adjusting the rotational speed of the lubricant application brush 421 stepwise, it is possible to prevent an excessive increase in the lubricant application amount, and it is possible to reduce the lubricant consumption amount for suppressing the frictional vibration at the cleaning member 41.

FIG. 7 is a diagram illustrating an example of an analysis result of the vibration mode obtained by the vibration control processing through durability. In FIG. 7, the frequency B derived from the driving is 434 Hz. In addition, in the vibration control processing, ladder patterns in which the pitch has been changed stepwise in a range of 1.40 mm to 1.80 mm have been output.

An amplitude spectrum S11 in FIG. 7 is an analysis result at a relatively initial stage after the photoreceptor unit is replaced. In the amplitude spectrum S11, a peak P1 appears around 407 Hz in addition to that of the frequency components derived from the driving, which appears at 434 Hz. 407 Hz is the spatial frequency of a ladder pattern of 1.63 mm pitch. Thus, the frequency A derived from the blade is specified as 407 Hz. At this time, no CD pitch unevenness has appeared on the image.

An amplitude spectrum S12 is an analysis result at a stage at which the durability has progressed. In the amplitude spectrum S12, a peak P2 appears around 429 Hz in addition to that of the frequency component derived from the driving. 429 Hz is the spatial frequency of a ladder pattern of 1.55 mm pitch. Thus, the frequency A derived from the blade is specified as 429 Hz. It can be understood from the amplitude spectra S11 and S12 that the frequency A derived from the blade approaches the frequency B derived from the driving as the durability progresses. At this time, no CD pitch unevenness has appeared on the image. It can be understood that there is a low possibility that resonance will occur at the photosensitive drum 213 due to the vibration derived from the blade when the difference between the frequency A derived from the blade and the frequency B derived from the driving is equal to or greater than 5 Hz.

An amplitude spectrum S13 is an analysis result at a stage at which the durability has further progressed. In the amplitude spectrum S13, an extremely large peak P3 appears around 432 Hz. This indicates that the vibration derived from the driving and the vibration derived from the blade have resonated. In addition, CD pitch unevenness of 1.51 mm pitch has appeared on the image. Thus, it can be said that resonance occurs at the photosensitive drum 213 when the difference between the frequency A derived from the blade and the frequency B derived from the driving becomes 3 Hz. In this case, it is necessary to change the image formation conditions to shift the frequency derived from the blade.

An amplitude spectrum S14 is an analysis result after the rotational speed of the lubricant application brush 421 is changed as an example of the image formation conditions in a state in which the amplitude spectrum S13 has been obtained. In the amplitude spectrum S14, a peak P4 appears around 439 Hz in addition to that of the frequency component derived from the driving. 439 Hz is the spatial frequency of a ladder pattern of 1.49 mm pitch. Thus, the frequency A derived from the blade is specified as 439 Hz. At this time, no CD pitch unevenness has appeared on the image.

An amplitude spectrum S15 is an analysis result after a toner band is formed in an inter-image region as an example of the image formation conditions in a state in which the amplitude spectrum S13 has been obtained. In the amplitude spectrum S15, a peak P5 appears around 380 Hz in addition to that of the frequency component derived from the driving. 380 Hz is the spatial frequency of a ladder pattern of 1.72 mm pitch. Thus, the frequency A derived from the blade is specified as 380 Hz. At this time, no CD pitch unevenness has appeared on the image.

It is understood from the amplitude spectra S11 to S13 that there is a low possibility that the photosensitive drum 213 will resonate due to the vibration derived from the blade, and CD pitch unevenness can be prevented when the difference between the frequency A derived from the blade and the frequency B derived from the driving is equal to or greater than 5 Hz.

In addition, it can be understood from the amplitude spectra S13 to S15 that it is effective to change the rotational speed of the lubricant application brush 421 and to form a toner band in an inter-image region in order to keep the frequency A derived from the blade away from the frequency B derived from the driving. In addition, it can be said that the effect of changing the frequency A derived from the blade is higher when a toner band is formed in an inter-image region than when the rotational speed of the lubricant application brush 421 is changed.

Although the frequency A derived from the blade is specified based on fluctuations in the drive torque of the photosensitive drum 213 in the embodiment described above, the transfer images of the ladder patterns 60 transferred onto the intermediate transfer belt 221 may be read, and the frequency A derived from the blade may be specified based on the reading results. Note that, the transfer images of the ladder patterns 60 transferred onto the recording material may be read, and the frequency A derived from the blade may be specified based on the reading results. In addition, the frequency A derived from the blade may also be specified by combining the vibration analysis result of the vibration mode of the photosensitive drum 213 and the reading results of the transfer images.

In a case where irregular disturbance is detected in the transfer image of a ladder pattern 60, it is possible to know that resonance occurs at the photosensitive drum 213, and further the spatial frequency of the ladder pattern 60 can be specified as the frequency A derived from the blade.

In a case where the frequency A derived from the blade is specified by the vibration analysis of the vibration mode of the photosensitive drum 213, the vibration derived from the blade and the vibrations derived from the ladder patterns may interfere with each other and weaken each other, and, a peak may not be detected depending on the number of repetitions of the vibration detection processing. By using the reading results of the transferred images of the ladder patterns 60, it is possible to know whether resonance occurs at the photosensitive drum 213, and it is possible to ensure that the frequency A derived from the blade is specified. In a case where resonance of the photosensitive drum 213 is recognized from the reading results of the transfer images, the number of repetitions of the vibration detecting processing may be increased until a peak of the frequency component derived from the blade is detected.

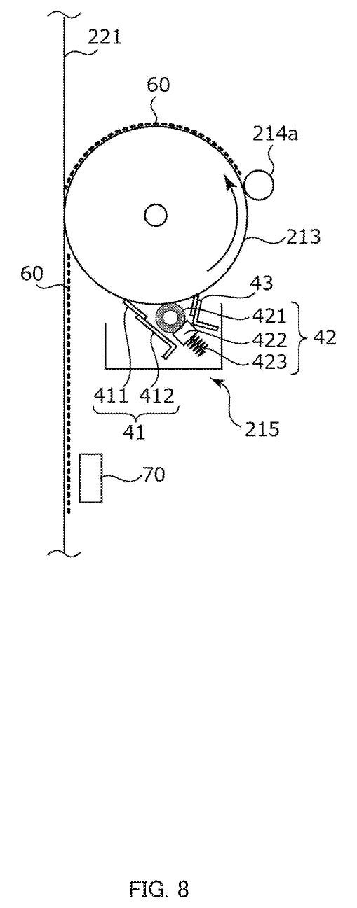

FIG. 8 illustrates a configuration in a case where a transfer image of a ladder pattern 60 transferred onto the intermediate transfer belt 221 is read. In FIG. 8, a reading section 70 is disposed so as to face the transfer surface of the intermediate transfer belt 221. The reading section 70 is a so-called scanner. The reading section 70 reads the image on the intermediate transfer belt 221, which has been transferred from the photosensitive drum 213, and generates a read image (read image data). The read image is transmitted to the control section 30 of the image forming apparatus 1.

The reading section 70 is a color line sensor capable of reading an entire width range in the width direction (the main scanning direction) of the intermediate transfer belt 221. The reading section 70 includes, for example, an LED light source, an optical system, and a sensor array. The LED light source emits laser light to the surface of the intermediate transfer belt 221. The optical system forms an image of reflected light from the intermediate transfer belt 221 on the sensor array. The optical system includes a plurality of mirrors, lenses, filters, and the like. The sensor array includes a plurality of optical elements arranged in a line shape along the width direction. The optical element is, for example, a photodiode, a charge coupled device (CCD), or a complementary metal oxide semiconductor (CMOS).

As described above, the image forming apparatus 1 according to the embodiment includes the following features singly or in appropriate combination.

That is, the image forming apparatus 1 according to the embodiment includes: the photosensitive drum 213 (image carrier); the cleaning member 41 that cleans the surface of the photosensitive drum 213; the image former 20 that forms a predetermined image pattern having regularity on the photosensitive drum 213; and the vibration specifying section that specifies the frequency A derived from the blade (the natural frequency of the cleaning member) based on the vibration mode of the photosensitive drum 213 when the predetermined image pattern is formed. In the image forming apparatus 1, the control section 30 constituted by a hardware processor functions as the vibration specifying section.

In addition, the vibration detection method according to the embodiment includes: forming a predetermined image pattern having regularity on the photosensitive drum 213 (image carrier); detecting the vibration mode of the photosensitive drum 213 when the predetermined image pattern is formed; and specifying, based on a detection result, the frequency A derived from the blade (the natural frequency of the cleaning member).

According to the image forming apparatus 1 and the vibration detection method, it is possible to specify the frequency A derived from the blade by forming the ladder pattern 60 on the photosensitive drum 213, and to change the frequency A derived from the blade by taking appropriate measures immediately before resonance occurs at the photosensitive drum 213. Accordingly, it is possible to efficiently reduce image defects such as CD pitch unevenness and improve the image quality.

In the image forming apparatus 1, the predetermined image pattern is the ladder pattern 60 formed at a pitch that is uniform in the rotation direction of the photosensitive drum 213 (image carrier), and the image former 20 forms a plurality of the ladder patterns 60 having a plurality of different pitches. Thus, it is possible to easily specify the frequency A derived from the blade, which fluctuates due to the durability and the surrounding environmental factors.

In the image forming apparatus 1, the control section 30 as the vibration specifying section specifies the frequency A derived from the blade (the natural frequency of the cleaning member) by analyzing a frequency component of the vibration mode of the image carrier 213 (image carrier) obtained when the plurality of ladder patterns 60 is formed. Thus, the frequency A derived from the blade can be specified with accuracy.

In the image forming apparatus 1, the control section 30 as the vibration specifying section detects the frequency A derived from the blade (the natural frequency of the cleaning member) based on fluctuations in the drive torque of the photosensitive drum 213 (image carrier). Thus, the vibration mode of the photosensitive drum 213 can be easily acquired without using a sensor or the like.

In the image forming apparatus 1, the control section 30 as the vibration specifying section extracts the frequency component of which a peak is indicated by the drive torque, and specifies the frequency component as the frequency A derived from the blade (the natural frequency of the cleaning member). Thus, the frequency A derived from the blade can be specified with accuracy.

In the image forming apparatus 1, the control section 30 as the vibration specifying section reads a plurality of transfer images of the plurality of ladder patterns 60 transferred onto the intermediate transfer belt 221 or the recording material, and specifies the frequency derived from the blade (the natural frequency of the cleaning member) based on uniformity of the plurality of ladder patterns 60 in a reading result. Thus, even in a case where the vibration derived from the blade and the vibrations derived from the ladder patterns interfere with each other and weaken each other and a peak is not detected in the vibration analysis, the frequency A derived from the blade can be specified.

The image forming apparatus 1 further includes a determiner that compares the specified frequency A derived from the blade (the specified natural frequency of the cleaning member) with a predefined frequency B derived from the driving and determines whether the difference between the specified frequency A derived from the blade and the predefined frequency B derived from the driving is equal to or less than the predetermined value C. In the image forming apparatus 1, the control section 30 functions as the determiner. Thus, it is possible to quantitatively determine whether resonance occurs at the photosensitive drum 213 by the vibration derived from the blade.

The image forming apparatus 1 further includes an image formation condition setter that changes an image formation condition of the image former 20 based on a determination result of the control section 30 as the determiner. In the image forming apparatus 1, the control section 30 functions as the image formation condition setter. Thus, the frequency component derived from the blade can be changed and kept away from the frequency component derived from the driving, and it is possible to prevent resonance from occurring at the photosensitive drum 213.

In the image forming apparatus 1, the control section 30 as the image formation condition setter changes, as the image formation condition, the rotational speed of the lubricant application brush 421 (the lubricant application member) that supplies a lubricant to the photoreceptor drum 213 (image carrier) by abutting on the photoreceptor drum 213 and rotating. Thus, the frictional vibration occurring at the cleaning member 41 can be reduced and the frequency derived from the blade can be changed, and it is possible to easily keep the frequency component derived from the blade away from the frequency component derived from the driving.

In the image forming apparatus 1, the control section 30 as the image formation condition setter forms a toner band in an inter-image region (non-image region) of the photosensitive drum 213 (image carrier) as the image formation condition. Thus, the frictional vibration occurring at the cleaning member 41 can be further reduced and the frequency derived from the blade can be largely changed, and it is possible to ensure that the frequency component derived from the blade is kept away from the frequency component derived from the driving.

Although the invention made by the present inventors has been specifically described above based on the embodiment, the present disclosure is not limited to the above-described embodiment and can be modified without departing from the spirit thereof.

For example, the execution timing of the vibration control processing is not limited to the start time or the end time of the print job, and the vibration control processing may be executed in a case where a predetermined durability elapses. In addition, the timing with which the next vibration control processing is executed may be adjusted according to the difference between the frequency A derived from the blade and the frequency B derived from the driving, which is specified in the vibration control processing. For example, as the difference between the frequency A derived from the blade and the frequency B derived from the driving decreases, the interval between the execution timings may be shortened.

In addition, for example, the ladder patterns may be patterns in which the spatial frequency is continuously changed. In addition, the ladder patterns may be formed not only such that the spatial frequency is changed to be larger or smaller, but also such that the spatial frequency is randomly changed. Further, the ladder patterns do not need to be formed in the entire region of the photosensitive drum 213 in the longitudinal direction and may be formed in a concentrated manner only in the vicinity of the center in the longitudinal direction in which the cleaning member 41 is most likely to vibrate.

The present disclosure is also applicable to a monochrome image forming apparatus. In addition, the present disclosure is not limited to the image forming apparatus of an electrophotographic method, but is also applicable to an inkjet printing apparatus.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
an image carrier;
a cleaning member that cleans a surface of the image carrier;
an image former that forms a predetermined image pattern having regularity on the image carrier; and
a hardware processor that specifies a natural frequency of the cleaning member based on a vibration mode of the image carrier when the predetermined image pattern is formed.

2. The image forming apparatus according to claim 1, wherein:
the predetermined image pattern is a ladder pattern formed at a pitch that is uniform in a rotation direction of the image carrier, and
the image former forms a plurality of the ladder patterns having a plurality of the pitches different from each other.

3. The image forming apparatus according to claim 2, wherein
the hardware processor specifies the natural frequency of the cleaning member by analyzing a frequency component of the vibration mode of the image carrier obtained when the plurality of ladder patterns is formed.

4. The image forming apparatus according to claim 3, wherein
the hardware processor detects the natural frequency of the cleaning member based on a fluctuation in drive torque of the image carrier.

5. The image forming apparatus according to claim 4, wherein
the hardware processor extracts the frequency component of which a peak is indicated by the drive torque, and the hardware processor specifies the frequency component as the natural frequency of the cleaning member.

6. The image forming apparatus according to claim 2, wherein
the hardware processor reads a plurality of transfer images of the plurality of ladder patterns transferred onto an intermediate transfer belt or a recording material, and specifies the natural frequency of the cleaning member based on uniformity of the plurality of ladder patterns in a reading result.

7. The image forming apparatus according to claim 6, wherein
in a case where the hardware processor detects irregular disturbance in a ladder pattern among the plurality of ladder patterns, the hardware processor specifies a spatial frequency of the ladder pattern as the natural frequency of the cleaning member.

8. The image forming apparatus according to claim 1, further comprising a determiner that compares the specified natural frequency of the cleaning member with a predefined frequency and determines whether a difference between the specified natural frequency and the predefined frequency is equal to or less than a predetermined value.

9. The image forming apparatus according to claim 8, further comprising an image formation condition setter that changes an image formation condition of the image former based on a determination result of the determiner.

10. The image forming apparatus according to claim 9, wherein
the image formation condition setter changes, as the image formation condition, a rotational speed of a lubricant application member that supplies a lubricant to the image carrier by abutting on the image carrier and rotating.

11. The image forming apparatus according to claim 9, wherein
the image formation condition setter forms a toner band in a non-image region of the image carrier as the image formation condition.

12. A vibration detection method, comprising:
forming a predetermined image having regularity on an image carrier;
detecting a vibration mode of the image carrier when the predetermined image is formed; and
specifying, based on a detection result, a natural frequency of a cleaning member that cleans a surface of the image carrier.
